(19) United States
(12) Patent Application Publication
(10) Pub. No.: US 2020/0399034 A1
(43) Pub. Date: Dec. 24, 2020

(54) CONTAINER LID ASSEMBLY

(71) Applicant: HUNG KUAN WU, TAIPEI CITY (TW)

(72) Inventor: HUNG KUAN WU, TAIPEI CITY (TW)

(21) Appl. No.: 16/444,181

(22) Filed: Jun. 18, 2019

(51) Int. Cl. B65D 51/24; A61J 1/03; A61J 7/04; B65D 83/04; B65D 50/06; B65D 41/04; B65D 51/18; B65D 47/28

(52) U.S. Cl. CPC B65D 51/24; A61J 1/03; A61J 7/04; B65D 83/0481; B65D 2251/06; B65D 41/04; B65D 51/18; B65D 47/283; B65D 50/061

(57) ABSTRACT

A container lid assembly includes a movable lid, a ratchet ring, a rotary symbol ring, an inner cover, and an annular housing. Once coupled to a container, the container lid assembly can automatically and accurately record the number of times for which it has been opened, thereby reminding the user of whether the contents of the container (e.g., medicine) have been used, lest the user miss a dose of the medicine or retake the medicine unnecessarily. The container lid assembly also allows a plurality of containers to be connected in series to facilitate carrying and management.

### BACKGROUND OF THE INVENTION

### 1. Technical Field

The present invention relates to structural improvement of a container lid. More particularly, the invention relates to a container lid assembly for use with a container that contains pills or other granular objects, wherein the container lid assembly can accurately record the number of times for which it has been opened.

### 2. Description of Related Art

A medicine container, such as a pill container, generally has so large an opening that it is difficult to tip out the desired number of pills in one go without pouring out of a load of pills or dropping the pills all over the place. This can be a serious issue to patients who tend to forget whether they have taken their medicine, for they may take a certain dose repeatedly or skip a dose or two without knowing it.

In view of the above, the inventor of the present invention developed a lid structure for overcoming the aforesaid drawback and was granted therefor Taiwan Utility Model Patent No. M359519 (“Structural improvement of container lid”) and Taiwan Utility Model Patent No. M377396 (“Further improvement of container lid”). Patent applications for the same utility models were also filed in the US and were allowed as U.S. Pat. No. 8,091,719 (“Container cap”) and U.S. Pat. No. 8,136,687 (“Cover of container”).

During the actual manufacturing processes of the two patented structures, however, the inventor found it difficult to mass-produce the necessary molds, and this eventually led to low production efficiency and high production cost.

Moreover, referring to FIG. 1, the primary objective and effect of the cover disclosed in U.S. Pat. No. 8,136,687 are for the cover (the movable lid 110) to record and display the number of times for which it has been opened, thereby reminding the user of whether he or she has taken the medicine in the container. However, as the medicine in the container 550 can be tipped out directly through the opening 1020d formed by lifting the movable lid 110, the user is very likely to forget that the lifted movable lid 110 must also be rotated in order to rotate the symbol ring 660 to the next position and thereby update the number of times of use.

The inventor soon realized that it is the operating procedure required by the cover structure that tends to result in a user's incomplete medicine withdrawing operation and hence inaccurate recording of the number of times of use.

In addition, a patient with a chronic disease may have to take more than one medicine and therefore may use multiple containers to store the medicines separately and to facilitate management of the medicines. Nevertheless, the multiplicity of the containers invites confusion and consequently difficulty in finding a certain container. When the containers are placed in a backpack, the backpacker's movement may displace the containers in different directions, making it even more time-consuming to find the desired container.

Urged by the need to better the existing structures, the inventor sought to make further improvement and finally succeeded in developing the superior structure disclosed herein.

The structural details, objectives, implementation method, and spirit of the present invention can be better understood by referring to the following detailed description in conjunction with the accompanying drawings.

### BRIEF SUMMARY OF THE INVENTION

The present invention relates to a structurally improved container lid that not only can accurately display the number of times for which the lid has been opened, but also allows a plurality of containers to be connected in series to facilitate management and carrying.

The primary objective of the present invention is to provide a container lid assembly and an operating procedure thereof that enable automatic update and display of the number of times of use as soon as the container lid assembly is opened, thereby reminding the user, e.g., a patient, of whether he or she has taken the medicine in a container, ensuring that the patient will not take the same dose again by accident but know exactly whether a dose is due. Furthermore, the container lid assembly of the invention makes it possible to connect a plurality of containers in series to facilitate management. Last but not least, it has been demonstrated that the structural design disclosed herein can be mass-produced and contribute to cost reduction.

### BRIEF DESCRIPTION OF THE SEVERAL VIEWS OF THE DRAWINGS

FIG. 1 shows three states of use of a conventional cover of a container as disclosed in U.S. Pat. No. 8,136,687;

FIG. 2 is an exploded perspective view of a container lid assembly according to the present invention;

FIG. 3 is a perspective view of the vertically movable member in FIG. 2;

FIG. 4 is a perspective view of the circular cover in FIG. 2;

FIG. 5 is a perspective view of the top cover in FIG. 2;

FIG. 6 shows the pin movement of the inner cover in FIG. 2;

FIG. 7 is a perspective view of the annular housing in FIG. 2;

FIG. 8 is a perspective view of a container for use with the container lid assembly in FIG. 2;

FIG. 9 is a perspective sectional view taken along line A-A in FIG. 13;

FIG. 10 is a perspective sectional view taken along line B-B in FIG. 13;

FIG. 11 shows how the movable lid in FIG. 2 is rotated to a predetermined position;

FIG. 12 is a perspective view in which the protuberances of the vertically movable member are respectively engaged in the corresponding sideways recesses of the rotary symbol ring;

FIG. 13 shows three states of use of the container lid assembly in FIG. 2;

FIG. 14 is a perspective view showing how pills are tipped out more desirably than in the prior art through the container lid assembly in FIG. 2; and

FIG. 15 shows how two containers as shown in FIG. 8 are connected in series by the container lid assembly in FIG. 2.

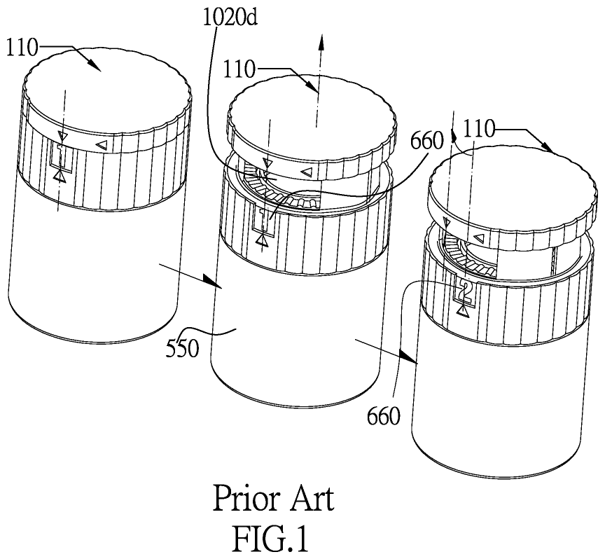

### DETAILED DESCRIPTION OF THE INVENTION

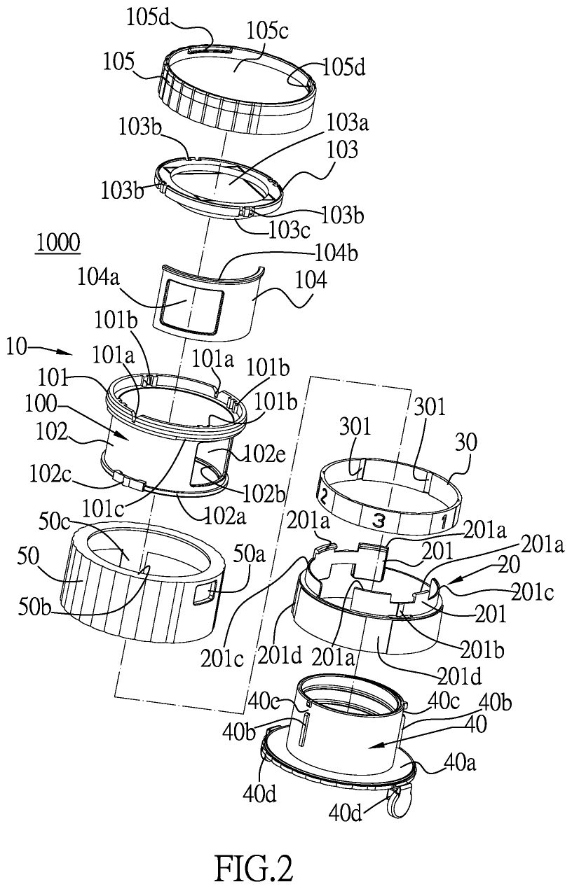

Referring to FIG. 2 for an exploded perspective view of a container lid assembly 1000 according to the present invention, the container lid assembly 1000 includes a movable lid 10, a ratchet ring 20, a rotary symbol ring 30, an inner cover 40, and an annular housing 50.

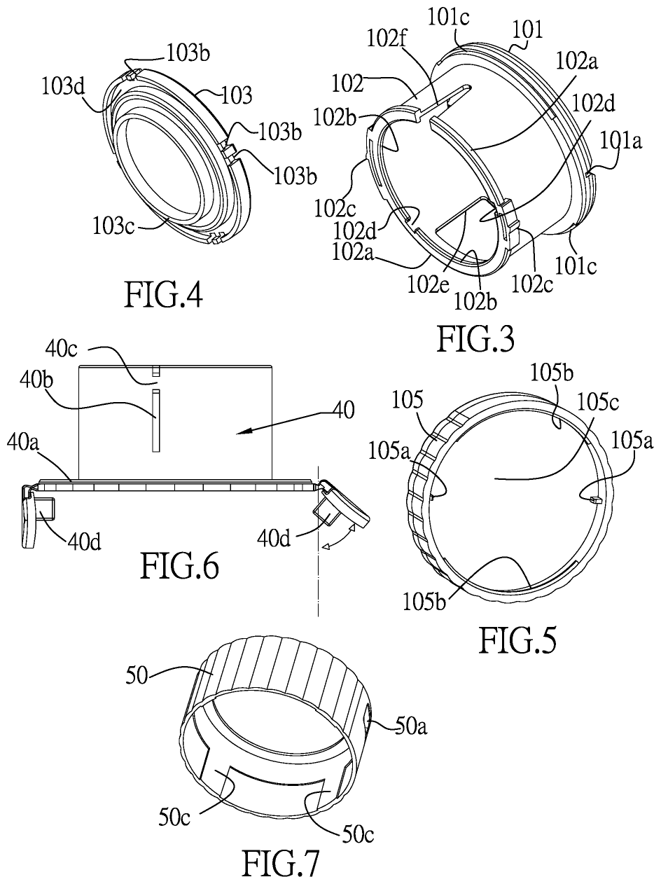

As shown in FIG. 2 and FIG. 3, the movable lid 10 includes a vertically movable member 100 configured as an insertion tube 102. An opening 102e is formed at the front side of the insertion tube 102. A protruding annular wall 101 extends upward from the outer periphery of the upper end of the insertion tube 102 and is formed with two notches 101a in a top portion. The inner side of the protruding annular wall 101 is provided with plural pairs of alternately arranged projections 101b. The bottom side of the protruding annular wall 101 is provided with a fastening groove 101c. An outer flange 102a and an inner flange 102b are provided on a bottom portion of the insertion tube 102. The outer flange 102a is provided with two corresponding protuberances 102c. The inner flange 102b is provided with two spaced-apart recesses 102d. A bottom portion of the insertion tube 102 is formed with a slit 102f extending upward from the outer flange 102a and the inner flange 102b. The slit 102f allows a lower portion of the insertion tube 102 to be temporarily constricted (i.e., temporarily reduced in diameter) during assembly. A circular cover 103 has a hollow portion 103a at the top side, and a chip is fixed in the hollow portion 103a. The bottom side of the circular cover 103 is provided with an annular concave track 103d and a protruding insertion tube 103c (see FIG. 4). The outer periphery of the circular cover 103 is provided with plural pairs of alternately arranged engaging grooves 103b. The circular cover 103 is fixedly positioned on the vertically movable member 100 through engagement between the engaging grooves 103b of the circular cover 103 and the plural pairs of alternately arranged projections 101b on the inner side of the protruding annular wall 101 of the insertion tube 102. An arcuate plate 104 has an opening 104a on a lateral side and is provided with a flange 104b along the top side. Referring to FIG. 9 and FIG. 10, the arcuate plate 104 is located behind the opening 102e of the insertion tube 102 (i.e., the vertically movable member 100) to close the opening 102e, with a bottom portion of the arcuate plate 104 sitting on the inner flange 102b on the bottom portion of the insertion tube 102, and with the flange 104b of the arcuate plate 104 extending into the annular concave track 103d at the bottom side of the circular cover 103. A top cover 105 (see FIG. 2, FIG. 3, FIG. 5, and FIG. 9) is configured as a tubular cover, with a partition plate 105c provided therein and two blocks 105a provided on a bottom portion of the partition plate 105c. The blocks 105a correspond to and are positioned in the notches 101a in the protruding annular wall 101 of the insertion tube 102 respectively. The bottom inner periphery of the top cover 105 is provided with a protruding fastening flange 105b to be fastened to the fastening groove 101c in the bottom side of the protruding annular wall 101 of the insertion tube 102. The top inner periphery of the top cover 105 is provided with a plurality of protruding gripping flanges 105d.

The chip provided in the hollow portion 103a of the circular cover 103 can be used to record or read a patient's data and medicine-related data.

As shown in FIG. 2, the ratchet ring 20 has an annular body whose inner periphery is provided with two upwardly extending and corresponding ratchet tooth features 201. Each ratchet tooth feature 201 includes a gripping portion 201a, an angled tooth 201b, and a supporting plate 201c extending from a lateral side of the gripping portion 201a. The annular outer periphery of the ratchet ring 20 is provided with a plurality of recessed portions 201d. Referring to FIG. 9 and FIG. 10, the two ratchet tooth features 201 are inserted into the rotary symbol ring 30, in order for the angled teeth 201b of the two ratchet tooth features 201 to engage with the corresponding sideways recesses 301 in the inner periphery of the rotary symbol ring 30 respectively, allowing the rotary symbol ring 30 to be rotated in one direction only.

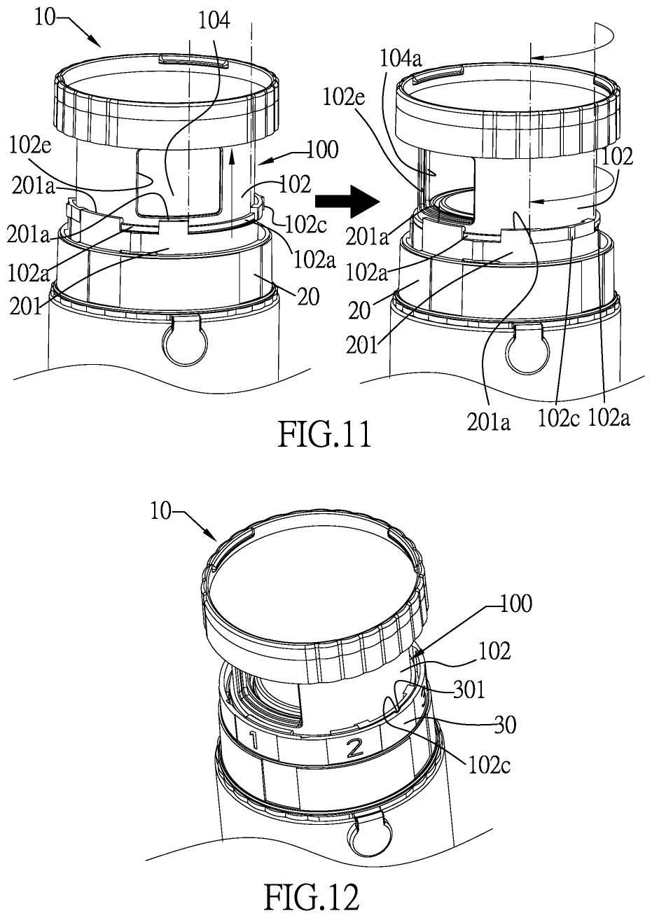

The movable lid 10 is inserted into, and vertically movable in, the ratchet ring 20. When the movable lid 10 is pulled upward to a predetermined position as shown in FIG. 9, the gripping portions 201a of the two ratchet tooth features 201 are hooked to the outer flange 102a of the insertion tube 102 (i.e., the vertically movable member 100) of the movable lid 10 to prevent detachment of the movable lid 10. In addition, referring to FIG. 12, the two protuberances 102c of the vertically movable member 100 of the movable lid 10 are engaged with the corresponding sideways recesses 301 of the rotary symbol ring 30 respectively.

The rotary symbol ring 30 has an annular body and is provided with a plurality of symbols on the outer periphery and the sideways recesses 301 in the inner periphery.

Referring to FIG. 2 in conjunction with FIG. 6, the inner cover 40 has a tubular body with a threaded inner periphery and is provided with an annular bottom plate 40a at a bottom portion. The outer periphery of the tubular body of the inner cover 40 is provided with two spaced-apart ribs 40b, with an opening 40c in an upper portion of each rib 40b so that the inner flange 102b on the bottom portion of the insertion tube 102 (see FIG. 3) can move in the openings 40c. The inner flange 102b on the bottom portion of the insertion tube 102 can also move in the gap between a bottom portion of each rib 40b and the annular bottom plate 40a. The outer periphery of the annular bottom plate 40a is provided with two pins 40d that can be lifted and lowered in a pivotal manner.

Referring also to FIG. 3, FIG. 9, and FIG. 10, the inner cover 40 is coupled in the insertion tube 102 (i.e., the vertically movable member 100) of the movable lid 10 in such a way that the two ribs 40b on the inner cover 40 correspond to and are vertically movable in the two recesses 102d in the inner flange 102b on the bottom portion of the insertion tube 102 respectively, and that the arcuate plate 104, which is inside the vertically movable member 100 of the movable lid 10, lies between and is confined by the two ribs 40b of the inner cover 40 and therefore can only be moved up and down in a reciprocating manner between the ribs 40b.

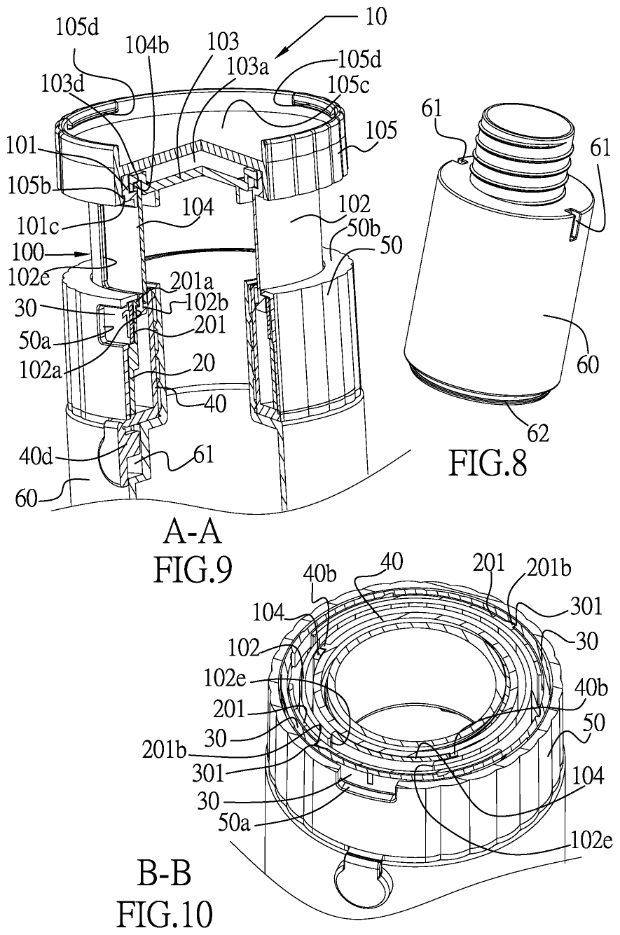

Referring to FIG. 2 in conjunction with FIG. 7, FIG. 9, and FIG. 10, the annular housing 50 has an annular body formed with an opening 50a. A top portion of the annular housing 50 is protrudingly provided with a top edge 50b while the inner periphery of the annular housing 50 is provided with a plurality of protruding plates 50c corresponding respectively to the recessed portions 201d of the outer periphery of the ratchet ring 20. The ratchet ring 20 coupled with the rotary symbol ring 30 is inserted into the annular housing 50, with the protruding plates 50c on the inner periphery of the annular housing 50 inserted respectively into the recessed portions 201d of the outer periphery of the ratchet ring 20, and with the top edge 50b of the annular housing 50 lying above the ratchet tooth features 201 of the ratchet ring 20 and the rotary symbol ring 30 coupled thereto to prevent detachment of the ratchet ring 20 and the rotary symbol ring 30. The opening 50a of the annular housing 50 corresponds to the rotary symbol ring 30 so that any symbol aligned with the opening 50a is visible through the opening 50a. The container lid assembly 1000 is completed when the bottom edge of the annular housing 50 is fixedly coupled to the annular bottom plate 40a of the inner cover 40. As shown in FIG. 6, FIG. 8, and FIG. 9, the container lid assembly 1000 can be threadedly connected to a container 60 with two fastening holes 61 that are configured to match the two pins 40d on the inner cover 40 respectively, and by pressing the two pins 40d of the inner cover 40 into the fastening holes 61 of the container 60 respectively, the container lid assembly 1000 is kept from getting loose.

Referring to FIG. 8 and FIG. 15, the two fastening holes 61 are provided in an upper portion of the container 60 while a connecting ledge 62 is provided on a bottom portion of the container 60. The connecting ledge 62 can be fastened to the protruding gripping flanges 105d on the top inner periphery of the top cover 105, thereby enabling a plurality of containers 60 to be connected in series.

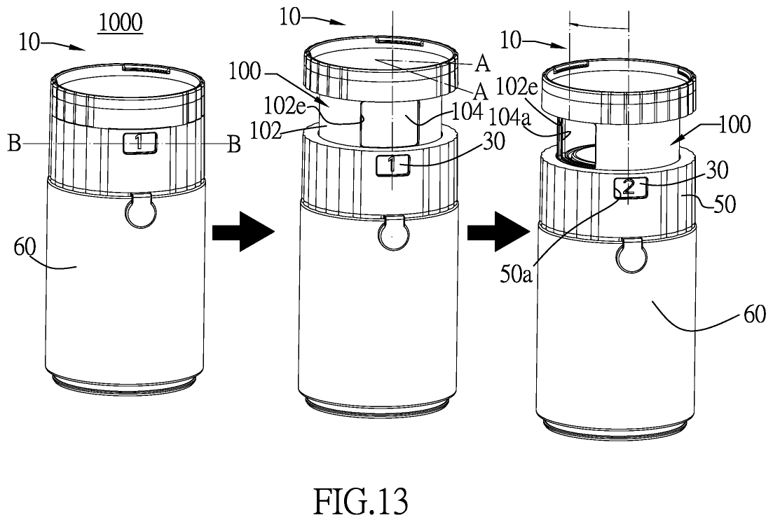

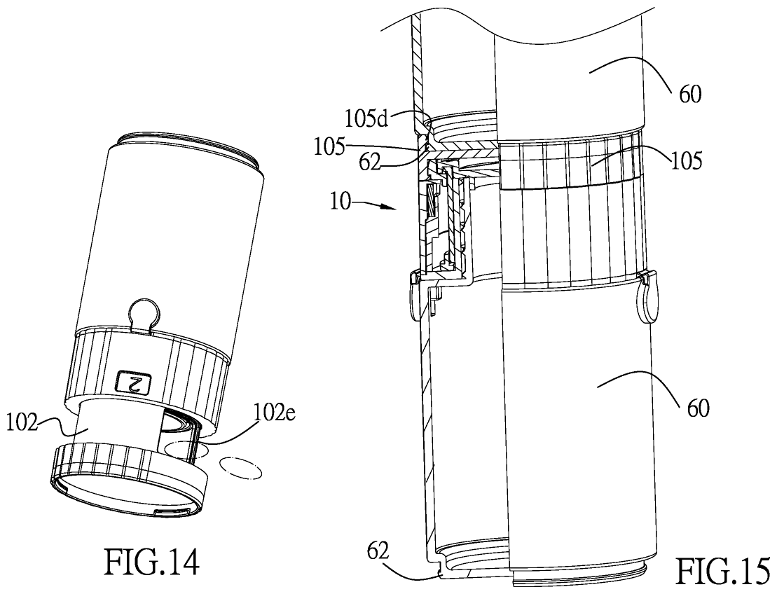

FIG. 13 shows how the container lid assembly 1000 is used. The container 60 in FIG. 13 is threadedly connected to and sealed by the container lid assembly 1000. When it is desired to take pills out of the container 60, the movable lid 10 is pulled upward to a predetermined position such that, referring to FIG. 9, FIG. 10, and FIG. 11, the gripping portions 201a of the ratchet tooth features 201 of the ratchet ring 20 are hooked to the outer flange 102a of the insertion tube 102 (i.e., the vertically movable member 100) of the movable lid 10 to prevent the movable lid 100 from detachment. In this state, the opening 102e of the insertion tube 102 is closed by the arcuate plate 104 standing behind it, and the protuberances 102c on the vertically movable member 100 of the movable lid 10 are engaged with the corresponding sideways recesses 301 of the rotary symbol ring 30 respectively (see FIG. 11 and FIG. 12). Then, the movable lid 10 is rotated, with the bottom portions of the protuberances 102c on the vertically movable member 100 of the movable lid 10 staying respectively on the supporting plates 201c of the ratchet ring 20 to prevent the movable lid 10 from descending. When the movable lid 10 in rotation reaches a predetermined position, the protuberances 102c are in abutment against sidewalls of the gripping portions 201a of the ratchet tooth features 201 respectively, the opening 102e of the insertion tube 102 is in alignment with the opening 104a of the arcuate plate 104, forming a hole in communication with the interior space of the container 60, and the rotary symbol ring 30 has been rotated from the previous position to the current position (e.g., from the position where the symbol “1” is visible through the opening 50a of the annular housing 50 to the position where the next symbol “2” can be seen) to indicate the number of times of use. The pills in the container 60 can now be poured out through the opening 102e at the front side of the insertion tube 102, as shown in FIG. 14.

To close the container lid assembly 1000 after the desired number of pills are obtained, the foregoing steps are performed in reverse order and in the opposite direction. During the reverse operation, referring to FIG. 10, the angled teeth 201b of the ratchet tooth features 201 are pressed respectively against walls of the corresponding sideways recesses 301 of the rotary symbol ring 30 to keep the rotary symbol ring 30 from reverse rotation; in other words, the rotary symbol ring 30 can only be rotated in one direction and will not be rotated by the reverse operation. Consequently, the symbol displayed through the opening 50a of the annular housing 50 remains unchanged, serving as a reminder of the number of times of use.

What is claimed is:

1. A container lid assembly, comprising:
a movable lid comprising a vertically movable member, a circular cover, an arcuate plate, and a top cover, wherein the vertically movable member is configured as an insertion tube, the insertion tube has a front side formed with an opening, a protruding annular wall extends upward from an outer periphery of an upper end of the insertion tube and has a top portion formed with two notches, the protruding annular wall has an inner side provided with plural pairs of alternately arranged projections, the protruding annular wall has a bottom side provided with a fastening groove, the insertion tube has a bottom portion provided with an outer flange and an inner flange, the outer flange is provided with two corresponding protuberances, the inner flange is provided with two spaced-apart recesses, the bottom portion of the insertion tube is formed with a slit extending upward from the outer flange and the inner flange, the slit allows a lower portion of the insertion tube to be temporarily reduced in diameter during assembly, the circular cover has a top side provided with a hollow portion, a chip is fixed in the hollow portion, the circular cover has a bottom side provided with an annular concave track and a protruding insertion tube, the circular cover has an outer periphery provided with plural pairs of alternately arranged engaging grooves, the circular cover is fixedly positioned on the vertically movable member through engagement between the engaging grooves of the circular cover and the plural pairs of alternately arranged projections on the inner side of the protruding annular wall of the insertion tube, the arcuate plate has a lateral side formed with an opening and has a top side provided with a flange, the arcuate plate is located behind the opening of the insertion tube to close the opening of the insertion tube, the arcuate plate has a bottom portion sitting on the inner flange on the bottom portion of the insertion tube, the flange of the arcuate plate extends into the annular concave track at the bottom side of the circular cover, the top cover is configured as a tubular cover and is provided therein with a partition plate, the partition plate has a bottom portion provided with two blocks, the blocks correspond to and are positioned in the notches in the protruding annular wall of the insertion tube respectively, the top cover has a bottom inner periphery provided with a protruding fastening flange, the protruding fastening flange is fastened to the fastening groove in the bottom side of the protruding annular wall of the insertion tube, and the top cover has a top inner periphery provided with a plurality of protruding gripping flanges;
a ratchet ring having an annular body, wherein the ratchet ring has an inner periphery provided with two upwardly extending and corresponding ratchet tooth features, each said ratchet tooth feature comprises a gripping portion, an angled tooth, and a supporting plate extending from a lateral side of the gripping portion, the rachet ring has an annular outer periphery provided with a plurality of recessed portions, the two ratchet tooth features are inserted into a rotary symbol ring in order for the angled teeth of the two ratchet tooth features to engage with corresponding ones of a plurality of sideways recesses in an inner periphery of the rotary symbol ring respectively, allowing the rotary symbol ring to be rotated in one direction only, the movable lid is inserted into, and vertically movable in, the ratchet ring, and when the movable lid is lifted to a predetermined position, not only are the gripping portions of the two ratchet tooth features hooked to the outer flange of the insertion tube of the movable lid to prevent detachment of the movable lid, but also the two protuberances of the vertically movable member of the movable lid are engaged with corresponding ones of the sideways recesses of the rotary symbol ring respectively;
the rotary symbol ring, wherein the rotary symbol ring has an annular body, an outer periphery provided with a plurality of symbols, and the inner periphery provided with the sideways recesses;
an inner cover having a tubular body, a threaded inner periphery, a bottom portion provided with an annular bottom plate, and an outer periphery provided with two spaced-apart ribs, wherein each said rib has an upper portion provided with an opening, the inner flange on the bottom portion of the insertion tube is movable in the openings of the ribs and also in a gap between a bottom portion of each said rib and the annular bottom plate, the annular bottom plate has an outer periphery provided with two movable pins, and the inner cover is coupled in the insertion tube of the movable lid in such a way that the two ribs on the inner cover correspond to and are vertically movable in the two recesses in the inner flange on the bottom portion of the insertion tube respectively, and that the arcuate plate in the vertically movable member of the movable lid lies between and is confined by the two ribs of the inner cover and is therefore movable only vertically in a reciprocating manner between the ribs; and
an annular housing having an annular body formed with an opening, wherein the annular housing has a top portion protrudingly provided with a top edge, the annular housing has an inner periphery provided with a plurality of protruding plates corresponding respectively to the recessed portions of the outer periphery of the ratchet ring, the ratchet ring coupled with the rotary symbol ring is inserted into the annular housing such that not only are the protruding plates on the inner periphery of the annular housing inserted into the recessed portions of the outer periphery of the ratchet ring respectively, but also the top edge of the annular housing lies above the ratchet tooth features of the ratchet ring and the rotary symbol ring coupled thereto to prevent detachment of the ratchet ring and the rotary symbol ring, the opening of the annular housing corresponds to the rotary symbol ring in order to display each said symbol aligned with the opening of the annular housing, the container lid assembly is fully assembled when a bottom edge of the annular housing is fixedly coupled to the annular bottom plate of the inner cover, the fully assembled container lid assembly is threadedly connectable to a container with two fastening holes configured to match the two pins on the inner cover respectively so that the container lid assembly is kept from getting loose after the two pins of the inner cover are pressed into the fastening holes of the container respectively, the two fastening holes are provided in an upper portion of the container, the container has a bottom portion provided with a connecting ledge, and the connecting ledge is fastenable to the protruding gripping flanges on the top inner periphery of the top cover to enable a plurality of said containers to be connected in series;
wherein when the container lid assembly is connected to the container and the movable lid is lifted to the predetermined position, the gripping portions of the ratchet tooth features of the ratchet ring are hooked to the outer flange of the insertion tube of the movable lid to prevent detachment of the movable lid, the opening of the insertion tube is closed by the arcuate plate, which stands behind the opening of the insertion tube, and the protuberances on the vertically movable member of the movable lid are engaged with corresponding ones of the sideways recesses of the rotary symbol ring respectively; when the movable lid is subsequently rotated, bottom portions of the protuberances on the vertically movable member of the movable lid are on the supporting plates of the ratchet ring respectively to prevent the movable lid from descending; and when the movable lid in rotation reaches a predetermined position, the protuberances are in abutment against sidewalls of the gripping portions of the ratchet tooth features respectively, the opening of the insertion tube is in alignment with the opening of the arcuate plate, forming a hole in communication with an interior space of the container to allow contents of the container to be poured out through the opening at the front side of the insertion tube, and the rotary symbol ring has been rotated from a previous position, where a previous said symbol is displayed through the opening of the annular housing, to a current position, where a said symbol following the previous symbol is displayed through the opening of the annular housing, to indicate the number of times of use.
